(19) United States
(12) Patent Application Publication
(10) Pub. No.: US 2026/0042016 A1
(43) Pub. Date: Feb. 12, 2026

(54) ONE OR MORE NON-TRANSITORY COMPUTER-READABLE MEDIA, INFORMATION PROCESSING SYSTEM, AND INFORMATION PROCESSING METHOD

(71) Applicant: Nintendo Co., Ltd., Kyoto (JP)

(72) Inventors: Yusuke UCHIDA, Kyoto (JP); Shoichi OBAYASHI, Kyoto (JP)

(21) Appl. No.: 19/256,785

(22) Filed: Jul. 1, 2025

(30) Foreign Application Priority Data
Aug. 7, 2024 (JP) 2024-130660

(51) Int. Cl. A63F 13/65; A63F 13/803

(52) U.S. Cl. CPC A63F 13/65; A63F 13/803; A63F 2300/308

(57) ABSTRACT

An example of a game system according to an exemplary embodiment, after a first race in a course where a goal point is set in a first base area ends, presents a plurality of candidates including a candidate for a course of a first type including an inter-base route from the first base area to a second base area, and a candidate for a course of a second type including an intra-base route in a third base area different from the first base area as candidates for a course of a next second race to a player, and sets any of the plurality of candidates as a second course based on selection of the player.

### CROSS REFERENCE TO RELATED APPLICATION

This application claims priority to Japanese Patent Application No. 2024-130660 filed on Aug. 7, 2024, the entire contents of which are incorporated herein by reference.

### FIELD

An exemplary embodiment relates to one or more non-transitory computer-readable media, an information processing system, an information processing method, and an information processing apparatus that enable the execution of a racing game.

### BACKGROUND AND SUMMARY

Conventionally, there is a game system that performs a racing game in courses of a plurality of types.

In a conventional game, a movable body runs on the same path multiple times along a course, and there is room for improvement in setting a variety of courses.

An exemplary embodiment discloses a game program, an information processing system, an information processing method, and an information processing apparatus that are capable of performing a race on various courses on a field and setting a variety of courses.

The exemplary embodiment employs the following configurations.

### (First Configuration)

A first configuration is one or more non-transitory computer-readable media having stored therein instructions that, when executed, cause one or more processors of an information processing apparatus to execute game processing including: causing an operation object to run on a field in a virtual space based on an operation input; setting a plurality of base areas on the field; if a start instruction to start a race between the operation object and at least one movable object different from the operation object is given based on an operation input, setting on the field a course which corresponds to the determined race and which includes at least either of an intra-base route that is a path set in any one of the base areas and an inter-base route set as a path connecting two of the base areas and where a goal point is set in any of the base areas, and starting the race; causing the operation object and the movable object to run along the set course on the field in the race; after a first race in a course where a goal point is set in a first base area ends, generating, as candidates for a course of a next second race, candidates for a plurality of courses at least including a candidate of a first type corresponding to a course of the first type where a starting point is set in the first base area and which includes the inter-base route from the first base area to a second base area, and a candidate of a second type corresponding to a course of the second type where a starting point is set in a third base area different from the first base area and which includes an intra-base route in the third base area; selecting any of the candidates for the plurality of courses based on an operation input and determining the course of the second race based on the selection; and setting the determined course on the field and starting the second race.

Based on the above, it is possible to present candidates for a variety of courses as a course of a second race to a user and allow the user to select any of the candidates.

### (Second Configuration)

According to a second configuration, in the above first configuration, the course of the first type may be a plurality of courses including the inter-base route from the first base area to each of a plurality of the second base areas.

Based on the above, it is possible to present courses where objects move from a first base area to a plurality of second base areas joined to the first base area by a plurality of inter-base routes to the user and allow the user to select any of the courses.

### (Third Configuration)

According to a third configuration, in the above first or second configuration, the course of the first type may be a course where the intra-base route in the second base area is set after the inter-base route from the first base area to the second base area. The course of the second type may be a course where the operation object and the movable object take multiple laps around the intra-base route in the third base area.

Based on the above, no matter which of a course of a first type and a course of a second type a selected course is, it is possible to cause a player object to run an intra-base route in a base area.

### (Fourth Configuration)

According to a fourth configuration, in any of the above first to third configurations, the third base area may be set based on a first condition regarding a direction on the field from the first base area from among the plurality of base areas on the field.

Based on the above, it is possible to set a base area that satisfies a first condition regarding the direction from a first base as a third base area, and it is possible to vary courses of the second race.

### (Fifth Configuration)

According to a fifth configuration, in any of the above first to fourth configurations, the third base area may be set based on a second condition regarding a distance from the first base area from among the base areas on the field.

Based on the above, it is possible to set a base area that satisfies a second condition regarding the distance from a first base as a third base area, and it is possible to vary courses of the second race.

### (Sixth Configuration)

According to a sixth configuration, in any of the above first to fifth configurations, regarding the plurality of base areas on the field, evaluations may be calculated so that the further away from a direction from the first base area to the second base area a direction on the field from the first base area is, the higher the evaluation is, and the closer to a predetermined distance a distance from the first base area is, the higher the evaluation is, and the third base area may be set from base areas having the high evaluations based on the calculated evaluations.

Based on the above, it is possible to set a base area located in a direction different from the direction from a first base area to a second base area and close to a predetermined distance from the first base area as a third base area, and it is possible to vary courses of the second race.

### (Seventh Configuration)

According to seventh configuration, in any of the above first to sixth configurations, the second and third base areas may be set from base areas other than the base area that the operation object and the movable object reach or pass through in the most recent predetermined number of races among the base areas on the field.

Based on the above, it is possible to prevent a racing game using the same base area as a base area that objects pass through or reach in the most recent race from being performed.

### (Eighth Configuration)

According to an eighth configuration, in any of the above first to seventh configurations, the game processing may further include, after the first race ends, displaying a candidate presentation UI at least including information that identifies the second base area regarding the candidate of the first type and information that does not identify the third base area regarding the candidate of the second type.

Based on the above, a player can select a desired base area, or select a base area which is away from a base area where an object is currently present, and of which the destination is unknown.

### (Ninth Configuration)

According to a ninth configuration, in the above eighth configuration, the game processing may further include: generating, as a candidate for the course of the second race, a candidate of a third type corresponding to a course of the third type where a starting point is set in a fourth base area different from the first base area and which includes an intra-base route in the fourth base area; and displaying the candidate presentation UI further including information that identifies the fourth base area regarding the candidate of the third type.

Based on the above, the player can select a base area which is away from a base area where the object is currently present, and of which the destination is known.

### (Tenth Configuration)

According to a tenth configuration, in any of the above first to ninth configurations, the game processing may further include causing the operation object to run on the field before the race starts. The game processing may further include, before a third race as the first race starts, generating, as candidates for a course of the third race, candidates for a plurality of courses at least including the candidate of the first type corresponding to the course of the first type where a starting point is set in a fifth base area closest to a position of the operation object among the base areas and which includes the inter-base route from the fifth base area to a sixth base area, and the candidate of the second type corresponding to the course of the second type where a starting point is set in a seventh base area different from the fifth base area and which includes an intra-base route in the seventh base area.

Based on the above, also regarding a first race, it is possible to allow the user to select either of a candidate of a first type and a candidate of a second type.

### (Eleventh Configuration)

According to an eleventh configuration, in any of the above first to tenth configurations, the game processing may further include determining a course corresponding to the candidate selected based on an operation input as the course of the second race.

Based on the above, it is possible to set a candidate selected by a player as the course of the second race.

### (Twelfth Configuration)

According to a twelfth configuration, in any of the above first to tenth configurations, the game processing may further include: causing a plurality of players to perform a race based on communication; and determining any of candidates selected by the respective players as the course of the second race.

Based on the above, in a racing game performed by a plurality of players, it is possible to determine a course of a second race by selection of the plurality of players.

Another configuration may be an information processing system that executes the above game program, an information processing apparatus, or an information processing method.

According to the exemplary embodiment, it is possible to present candidates for a variety of courses as a course of a second race after a first race to a user.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the entirety of a field F in a virtual space;

FIG. 4 is an example non-limiting diagram showing an example of an intra-base route CA1 set in a base area A1;

FIG. 5 is an example non-limiting diagram showing an example of a vote screen for determining a course where a next racing game is to be performed;

FIG. 6 is an example non-limiting diagram showing the positional relationships between base areas indicated by icons in a case where the vote screen shown in FIG. 5 is displayed;

FIG. 7 is an example non-limiting diagram showing an example of the vote screen in a case where two base areas A2 and A4 are extracted as candidates of a first type, and the remaining two base areas are extracted as candidates of a second type;

FIG. 8 is an example non-limiting diagram showing the positional relationships between base areas indicated by icons on the vote screen shown in FIG. 7;

FIG. 9 is an example non-limiting diagram showing an example of the vote screen in a case where no candidate of the first type is extracted in a first process;

FIG. 10 is an example non-limiting diagram showing examples of various pieces of data used in processes shown in FIGS. 11 to 14;

FIG. 11 is an example non-limiting flow chart showing an example of a main process;

FIG. 12 is an example non-limiting flow chart showing an example of a vote process in step S5;

FIG. 13 is an example non-limiting flow chart showing an example of a second candidate extraction process in step S13; and

FIG. 14 is an example non-limiting flow chart showing an example of a racing game process in step S6.

### DETAILED DESCRIPTION OF NON-LIMITING EXAMPLE EMBODIMENTS

### (Game System Configuration)

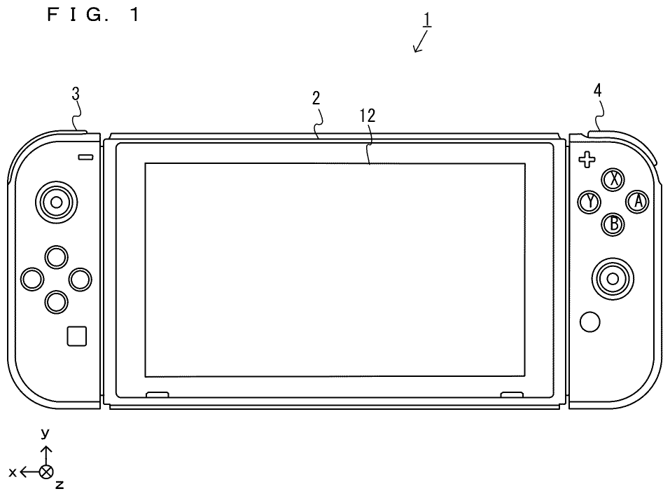

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons (an A-button, a B-button, an X-button, a Y-button, an L-button, and an R-button) and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

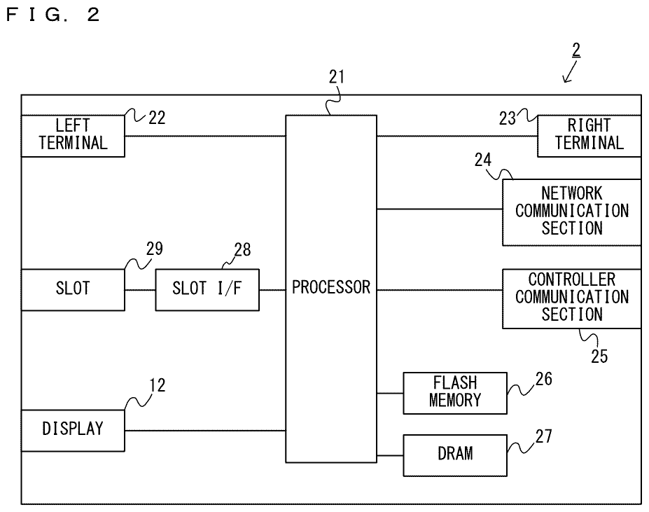

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., an external display device such as a television) separate from the display 12.

### (Overview of Game)

Next, an overview of a game executed by the game system 1 is described. A game according to the exemplary embodiment is a racing game where a player object (an example of an operation object) controlled by a player and another movable object controlled by another player or the processor 21 are caused to run on a field in a virtual space.

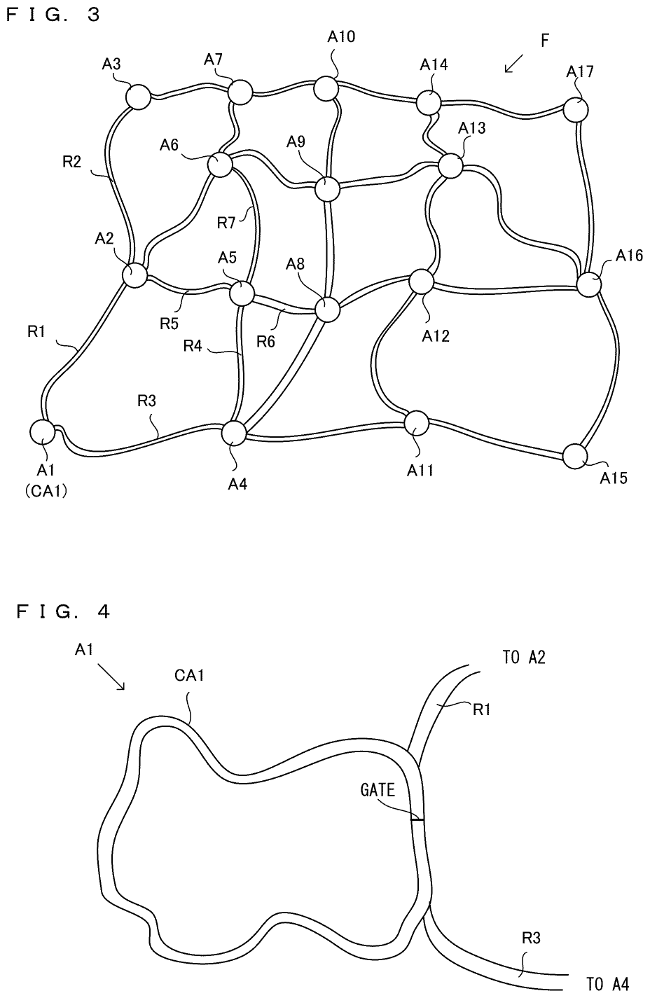

First, a description is given of a field in the virtual space where the racing game according to the exemplary embodiment is performed. FIG. 3 is a diagram showing an example of the entirety of a field F in the virtual space.

In the exemplary embodiment, a broad field F is set in the virtual space (a game space), and racing games are performed in various courses set on the field. As shown in FIG. 3, a plurality of base areas A are set on the field F in the virtual space. For example, as the plurality of base areas A, base areas A1 to A17 are represented as circles. Each base area A includes an intra-base route CA where the player object corresponding to the player can perform a racing game. For example, the base area A1 is an area indicating a single city. The base area A1 includes an intra-base route CA1 formed by a road where the player object can be caused to run. For example, the base area A2 includes an intra-base route CA2 that is a racing circuit.

A plurality of base areas are linked together by an inter-base route R where the player object can be caused to run. For example, the base areas A1 and A2 are linked together by an inter-base route R1. The base areas A1 and A4 are linked together by an inter-base route R3

Hereinafter, an intra-base route provided in a base area An (n is a positive integer) is referred to as an “intra-base route CAn”.

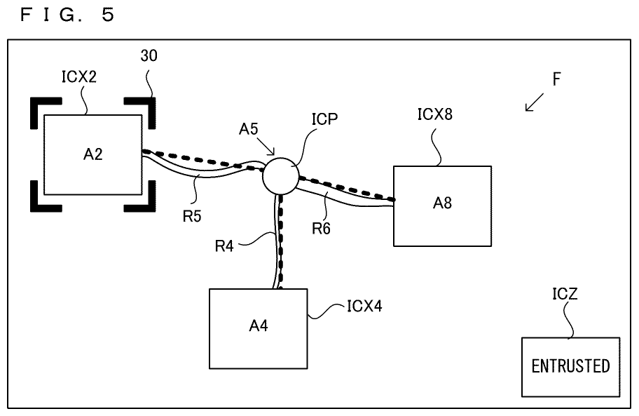

Next, an example of a base area is described. FIG. 4 is a diagram showing an example of the intra-base route CA1 set in the base area A1.

As shown in FIG. 4, in the base area A1, the intra-base route CA1 is provided. The intra-base route CA1 is a region where the player object can move. A road is formed along the intra-base route CA1. On the intra-base route CA1, a gate that can be a starting point and a goal point is provided. The intra-base route CA1 is connected to inter-base routes R1 and R3. The inter-base route R1 is a region where the player object can move, and is joined to the base area A2. The inter-base route R3 is a region where the player object can move, and is joined to the base area A4.

In the game according to the exemplary embodiment, there is a case where a racing game is performed where a course including an inter-base route R and an intra-base route CA joined to the inter-base route R is set, and the player object and another movable object are caused to run along the course. For example, a course where the player object starts from the starting point (the gate) set on the intra-base route CA1, runs the inter-base route R1 without taking a lap around the intra-base route CA1, enters the intra-base route CA2, takes a lap around the intra-base route CA2, and reaches a goal point (a gate) provided in the intra-base route CA2 is set. A course where the player object starts from a starting point set on the intra-base route CA2, runs an inter-base route R2 without taking a lap around the intra-base route CA2, enters the intra-base route CA3, takes a lap around the intra-base route CA3, and reaches a goal point provided on the intra-base route CA3 is also set.

Such a course including an inter-base route R and an intra-base route CA is referred to “a course of a first type”. The course of the first type may be a course where the player object takes one or more laps around an intra-base route CA where there is a starting point, enters an inter-base route R, and reaches an intra-base route CA joined to the inter-base route R.

In the exemplary embodiment, there is a case where a course where the player object starts from a starting point (a gate) of an intra-base route CA, takes multiple laps around the intra-base route CA, and reaches a goal point (the gate) is set. For example, a course where the player object takes multiple laps around the intra-base route CA1 is set, or a course where the player object takes multiple laps around the intra-base route CA2 is set. A course set so that the player object starts from a starting point of an intra-base route CA, takes multiple laps around the intra-base route CA, and reaches a goal point set on the intra-base route CA is referred to as “a course of a second type”.

In the game according to the exemplary embodiment, there is also case where a racing game is performed where a course is not set, and the player object runs through any position on the field F.

Next, the modes of the game are described. In the exemplary embodiment, there are a single play mode where a single player performs the game and a multiplay mode where a plurality of players perform the game.

In the single play mode, a single player controls a player object using the controller 3 and/or the controller 4, and the processor 21 of the main body apparatus 2 controls one or more other movable objects, whereby a racing game using a plurality of movable objects is performed.

The multiplay mode includes an offline multiplay mode and an online multiplay mode.

The offline multiplay mode is a mode where a plurality of controllers are wirelessly connected to a single main body apparatus 2, or a plurality of main body apparatuses 2 are connected together via a wireless or wired LAN or the like, and a plurality of players perform the game. Each of the plurality of players operates a player object of the player using the controllers of the player. The main body apparatus 2 acquires operation data regarding operations from the plurality of controllers based on wireless or wired communication and controls the player objects corresponding to the players.

The online multiplay mode is a mode where main body apparatuses 2 are connected to the Internet, and a plurality of players perform the game. The main body apparatuses 2 of the plurality of players transmit requests to perform a racing game in the online multiplay mode to a server on the Internet. The server matches the plurality of players in accordance with the requests. For example, if a predetermined number of players are matched, the racing game in the online multiplay mode is started. If the racing game is started, each player controls a player object corresponding to the player using the controllers. Specifically, each main body apparatus 2 controls a player object corresponding to the main body apparatus 2 based on operation data from the controllers and also transmits information regarding the player object (information regarding the position, the orientation, the velocity, and the action of the player object, and the like) to the server. Each main body apparatus 2 receives information regarding a player object corresponding to another player from another main body apparatus 2 via the server (information regarding the position, the orientation, the velocity, and the action of the other player, and the like). Each main body apparatus 2 controls the player object corresponding to the other player based on the received information.

A plurality of controllers can also be connected to a single main body apparatus 2, and a plurality of players can also perform the game in the online multiplay mode using the single main body apparatus 2. For example, two players operate two controllers connected to a main body apparatus 2, and the main body apparatus 2 is connected to the Internet, whereby the two players can perform the game in the online multiplay mode using the single main body apparatus 2. In this case, a screen of an external display device connected to the main body apparatus 2 is split into two regions, and an image including each player object is displayed in each of the split regions.

A plurality of main body apparatuses 2 directly communicate with each other via the Internet not via the server, whereby the racing game may be performed in the online multiplay mode.

### (Votes for Courses)

If an instruction to start the game according to the exemplary embodiment is given, until a predetermined ending condition holds true (e.g., a player gives an instruction to end the game), a plurality of racing games using a plurality of courses are performed in order. In the exemplary embodiment, in a case where a racing game is performed in the online multiplay mode or the offline multiplay mode, and after a previous racing game ends, a course where a next racing game is to be performed is determined by votes of a plurality of players.

FIG. 5 is a diagram showing an example of a vote screen for determining the course where the next racing game is to be performed. For example, in FIG. 5, the vote screen to be displayed after the previous racing game ends by a plurality of player objects reaching a goal point provided in the base area A5 is displayed. A base area A where a goal point is set in the previous racing game is occasionally referred to as an “origin area”. The “origin area” is a base area where the player objects are present at the time when the previous racing game ends. The course of the previous racing game may be a course of the first type where each player object passes through an inter-base route, or may be a course of the second type where each player object takes multiple laps around an intra-base route. After the previous racing game ends, a screen (a screen of a display 12 or an external display device) of each player displays the vote screen shown in FIG. 5. After a predetermined interval elapses since the previous racing game ends, the vote screen shown in FIG. 5 may be displayed.

As shown in FIG. 5, the vote screen displays an image representing a part of the field F including the origin area (here, the base area A5) where the player objects are present, and displays four candidates for a course as candidates for the course where the next racing game is to be performed. The vote screen presents candidates for a course of the first type (a course including an inter-base route) and candidates for a course of the second type (a course where the player objects take laps around an intra-base route) to the players.

For example, as shown in FIG. 5, a course where the player objects start from the origin area, pass through an inter-base route R5, and reach the base area A2, a course where the player objects start from the origin area, pass through an inter-base route R4, and reach the base area A4, and a course where the player objects start from the origin area, pass through an inter-base route R6, and reach the base area A8 are presented as candidates for the course of the first type. These candidates for the course of the first type are determined by a computer based on a predetermined algorithm described below.

Specifically, an icon ICP indicating the player objects, an icon ICX2 indicating the base area A2, an icon ICX4 indicating the base area A4, and an icon ICX8 indicating the base area A8 are displayed. A dashed line from the origin area (the icon ICP) to the icon ICX2 indicating the base area A2, a dashed line from the origin area to the icon ICX4 indicating the base area A4, and a dashed line from the origin area to the icon ICX8 indicating the base area A8 are also displayed. These dashed lines indicate that the origin area and the base areas A are joined together by the inter-base routes R. The vote screen displays the icon ICP indicating the player objects, the icon ICX2 indicating the base area A2, the icon ICX4 indicating the base area A4, and the icon ICX8 indicating the base area A8 in positional relationships corresponding to the positional relationships between these base areas on the field.

Hereinafter, an icon represented as an “icon ICX” is an icon that is in a form that allows the identification of a specific base area, and indicates a course where the player objects start from the origin area, pass through an inter-base route R, and reach the base area. In a case where an icon is referred to as an “icon ICXn” (n is a positive integer), n indicates the number of the base area. For example, an “icon ICX3” indicates a course where the player objects start from the origin area, pass through an inter-base route R, and reach the base area A3.

At the lower right of the vote screen, an icon ICZ with “entrusted” to which a dashed line does not extend from the origin area is placed. The icon ICZ is a candidate for a course of the second type and is determined by the computer based on a predetermined algorithm. The icon ICZ indicates any one base area that is not joined to the origin area by an inter-base route R among the plurality of base areas set on the field. The icon ICZ is displayed in a form that does not allow the players to recognize a specific base area. That is, the icon ICZ is displayed in a form that does not allow the identification of a base area A. In contrast, the icons ICX2, ICX6, and ICX8 are displayed in forms that allow the players to identify the base areas. For example, the icon ICX2 is an icon indicating the name and an image of the base area A2.

A course corresponding to the icon ICZ is referred to as an “entrusted course”. The “entrusted course” is a course where the player objects take multiple laps around an intra-base route CA in any one base area that is not joined to the origin area by an inter-base route R among the plurality of base areas set on the field. At the time when the vote screen is displayed, the “entrusted course” is internally determined by the computer. At the time when the vote screen is displayed, the “entrusted course” may not be determined by the computer. In this case, when the “entrusted course” is determined based on the results of votes of the players, it may be specifically determined which course the “entrusted course” is (which base area includes a course where the player objects take laps around an intra-base route CA).

Although the details will be described below, there is also a case where the vote screen displays an icon ICY indicating a course of the second type in addition to an icon ICX indicating a course of the first type and the icon ICZ indicating the “entrusted course”. The icon ICY is displayed in a form that allows identification of a specific base area.

The players select any of the four displayed candidates (the icons ICX2, ICX4, ICX8, and ICZ) using a cursor 30 and vote for the course corresponding to each icon. Based on the results of votes of the players, any of the four candidates is determined as the course of the next racing game.

For example, any of the four candidates is randomly determined. Specifically, a random lottery is held so that the selection rate of a course having a great number of votes is high. For example, in a case where a single voting right is given to a single player, and the game in the online multiplay mode is performed by 24 players, the number of all votes is 24. In this case, if the number of votes for the course indicated by the icon ICX2 is “8”, the number of votes for the course indicated by the icon ICX4 is “7”, the number of votes for the course indicated by the icon ICX8 is “5”, and the number of votes for the “entrusted course” is “4”, the selection rates of the courses are set to “ 8/24”, “ 7/24”, “ 5/24”, and “ 4/24”. Then, a random lottery is held based on the set selection rates. The course having the greatest number of votes may be determined as the course of the next racing game.

A plurality of controllers can be connected to a single main body apparatus 2, and a plurality of players can participate in the game in the online multiplay mode using the single main body apparatus 2. For example, two controllers can be wirelessly connected to a single main body apparatus 2, and two players can participate in the game in the online multiplay mode using the single main body apparatus 2. In this case, a single player may be able to vote for a single candidate on the vote screen on behalf of the two players, or each of the two players may be able to vote on the vote screen. If a single player votes for a single candidate on the vote screen on behalf of the two players, the number of votes for the candidate is “2”.

### (Algorithm for Generating Candidates for Next Course)

Next, an algorithm for generating candidates to be displayed on the vote screen is described.

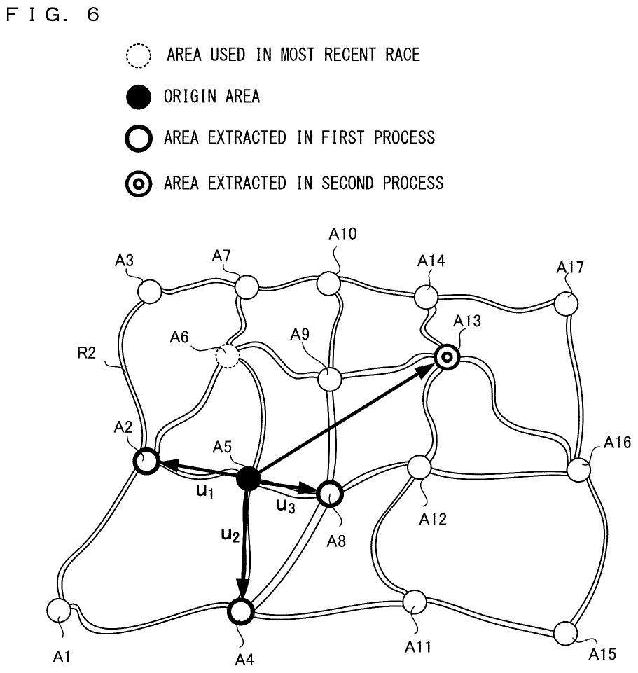

FIG. 6 is a diagram showing the positional relationships between the base areas indicated by the icons in a case where the vote screen shown in FIG. 5 is displayed.

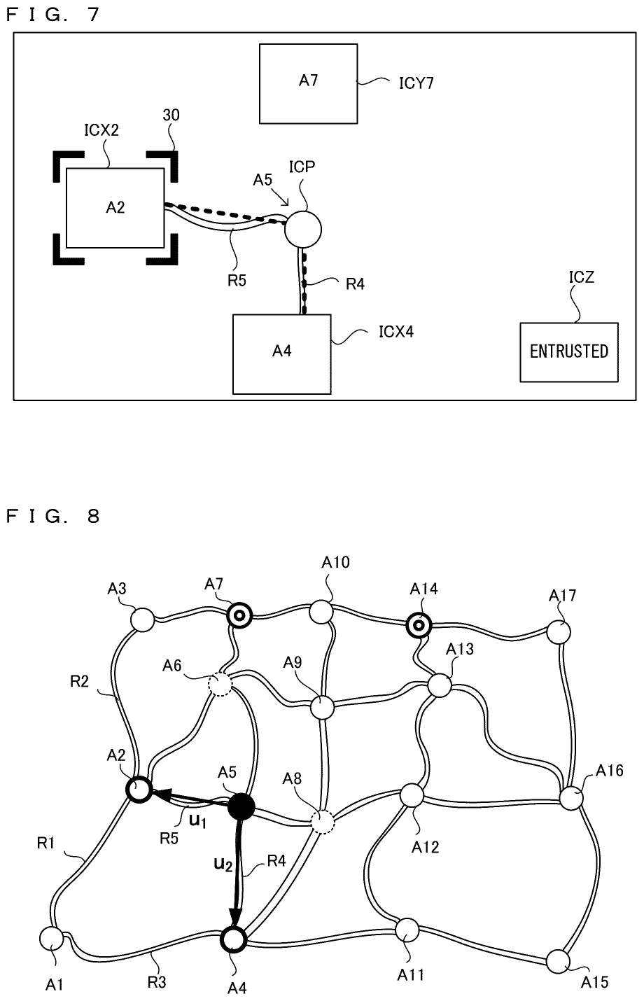

In the exemplary embodiment, four candidates for the course to be used in the next racing game are generated by a first process and a second process. First, as the first process, up to three base areas joined to an origin area by inter-base routes R are extracted. The candidates extracted in the first process are referred to as “candidates of the first type”. If a predetermined condition holds true, the number of candidates of the first type to be extracted in the first process is set to up to “2”. For example, if the course used in the previous racing game is not a course of the second type (i.e., is a course of the first type), the number of candidates of the first type to be extracted in the first process is up to “2” with a fixed probability. If an icon ICY shown in FIG. 7 described below is displayed on the previous vote screen, and when the current vote screen is generated, the number of candidates of the first type to be extracted in the first process is set to “3”.

Specifically, first, the number of candidates of the first type to be generated in the first process is determined by a random lottery. For example, the number of candidates of the first type is determined as “3” by the random lottery. In this case, if there are three or more base areas joined to the origin area by inter-base routes R, three base areas are randomly extracted from among the three or more base areas. Here, a base area used in the most recent predetermined number of races is eliminated from base areas as extraction targets. The “base area used in the most recent predetermined number of races” is a base area that the player objects reach or pass through in the most recent predetermined number of races. For example, the “base area used in the most recent predetermined number of races” is a base area where a starting point is set in a course of the first type, or a base area where a goal point is set in a course of the first type or a course of the second type in the most recent predetermined number of races.

In the example shown in FIG. 6, the course used in a previous racing game is a course where the base area A6 is a starting point and the base area A5 is a goal point. Additionally, the three base areas A2, A4, and A8 are not used in the most recent predetermined number of races. In this case, the three base areas A2, A4, and A8 other than the base area A6 among four base areas joined to the origin area by inter-base routes R are extracted in the first process. Consequently, three of the four candidates for the course of the next racing game are extracted. In FIG. 6, a base area A used in the most recent predetermined number of races is represented as a dashed circle. The three base areas A2, A4, and A8 extracted in the first process are represented as thick circles.

Next, in the second process, based on a condition regarding the direction on the field from the origin area and a condition regarding the distance from the origin area, at least any one of the plurality of base areas set on the field is extracted. As an example, the condition regarding the direction is a condition under which a base area in a direction as different from the direction from the origin area to a base area extracted in the first process as possible is likely to be selected. As an example, the condition regarding the distance is a condition under which a base area to which the distance from the origin area is close to a moderate distance is likely to be selected. For example, if the three base areas A2, A4, and A8 are extracted in the first process, a base area is extracted based on these three base areas A2, A4, and A8 and the origin area in the second process.

More specifically, regarding each base area set on the field, an evaluation value f(x) is calculated using the following formula 1.

$$f ( x ) = \{ \frac{x \cdot ( {\sum }_{n} {u}_{n} )}{2} + 1 \} A + L \frac{M {e}^{\frac{x}{M}}}{‖ x ‖} \qquad [ Math . 1 ]$$

Here, “x” is a vector from the origin area to the base area as the calculation target of the evaluation value. “un” is a vector from the origin area to an already extracted base area (candidate). “n” is the number of already extracted base areas. A, L, and M are constants, and e is the base of a natural logarithm.
f(x) is an evaluation based on the condition regarding the direction and the condition regarding the distance. Specifically, the first term on the right side of formula 1 is a value regarding the direction from the origin area. The smaller the angle between the vector “x” and the vector “un” is, the greater this value is. That is, a base area of which this value is small is a base area located in a direction opposite to the direction from the origin area to an already extracted base area A.

The second term on the right side of formula 1 is a value regarding the distance from the origin area. In a first range where the size of the vector “x” is greater than 0 and smaller than a first value, this value is relatively great. In a second range where the size of the vector “x” is greater than the first value and smaller than a second value, this value is relatively small. In a third range where the size of the vector “x” is greater than the second value, this value is relatively great. That is, in a base area too close to the origin area, this value is great. Also in a base area too far from the origin area, this value is great. In a base area that is not too close to or too far from the origin area and is somewhat away from the origin area, the value of the second term is small.

Thus, regarding a base area that is located in a direction opposite to the direction from the origin area to each already extracted base area and is somewhat away from the origin area, the value of f(x) (the evaluation value) is small.

Regarding base areas other than a base area used in the most recent predetermined number of races among all the base areas set on the field, the evaluation values are calculated using formula 1. Any one base area of the plurality of base areas of which the evaluation values are calculated is extracted. For example, any of the top four base areas having high evaluations (of which the evaluation values are small) is randomly extracted. For example, a lottery is held so that the higher evaluation (the smaller evaluation value) the base area has, the higher the probability of extraction of the base area is. The base area having the highest evaluation (the smallest evaluation value) may be extracted.

Here, in the second process, the base area A13 is extracted. In FIG. 6, the base area A13 extracted in the second process is represented as a double circle. A candidate for the course to be extracted in the second process is referred to as “a candidate of the second type”. The candidate of the second type is a base area that is located in a direction different from the directions from the origin area where the player objects are present when the previous racing game ends to the candidates of the first type, and is somewhat away from the origin area. A single candidate of the second type extracted in the second process is presented as the “entrusted course”.

As described above, the vote screen including the three icons (the icons ICX2, ICX4, and ICX8) indicating the three candidates of the first type extracted in the first process and the single icon (the icon ICZ) indicating the single candidate of the second type extracted in the second process is displayed.

There is a case where the number of candidates of the first type to be extracted in the first process is less than or equal to two. In this case, two or more candidate of the second type are extracted in the second process.

For example, there is a case where the number of candidates of the first type to be extracted is determined as “2” in the first process. There is also a case where even if the number of candidates of the first type to be extracted is determined as “3” in the first process, three candidates of the first type cannot be extracted. For example, even if the origin area is joined to three or more base areas by inter-base routes R, but if any of the joined base areas is used in the most recent predetermined number of races, the base area is not extracted in the first process. For example, the base area A5 is joined to four other base areas (A2, A4, A6, and A8) by inter-base routes R, but if the base areas A6 and A8 among these four base areas are used in the most recent predetermined number of races, the two base areas A2 and A4 are extracted as candidates of the first type in the first process. In this case, two candidates of the second type are extracted in the second process. One of the two candidates of the second type is presented as the “entrusted course”.

FIG. 7 is a diagram showing an example of the vote screen in a case where the two base areas A2 and A4 are extracted as candidates of the first type, and the remaining two base areas are extracted as candidates of the second type.

As shown in FIG. 7, the icon ICX2 corresponding to the course where the player objects start from the origin area (the base area A5), pass through the inter-base route R5, and reach the base area A2, and the icon ICX4 corresponding to the course where the player objects start from the origin area, pass through the inter-base route R4, and reach the base area A4 are displayed.

The icon ICZ indicating the “entrusted course” is displayed as one of the two candidates of the second type. Further, an icon ICY7 indicating the base area A7 is displayed as the other of the two candidates of the second type. The icon ICY7 is an icon indicating a course of the second type where the player objects take multiple laps around an intra-base route CA7 of the base area A7. A dashed line from the origin area to the icon ICY7 is not displayed. The icon ICY7 is displayed in a form that allows the identification of the base area A7 (the intra-base route CA7) similarly to the icons ICX2 and ICX4. For example, the icon ICY7 is an icon indicating the name and an image indicating the base area A7. The three icons ICX2, ICX4, and ICY7 on the vote screen are displayed in positional relationships corresponding to the positional relationships between the base areas on the field.

Hereinafter, an “icon ICYn” (n is a positive integer) indicates a course of the second type where the player objects take multiple laps around an intra-base route CA in a base area having a number indicated by n. The display forms of the icons ICXn and ICYn are different from each other.

The base area A7 is extracted based on an algorithm similar to that for the entrusted course. That is, based on the two base areas A2 and A4 extracted in the first process, regarding base areas other than a base area used in the most recent predetermined number of races among all the base areas set on the field, the evaluation values shown in formula 1 are calculated. Then, any of the top four base areas having high evaluations (of which the evaluation values are small) is randomly determined. Here, as a result, the base area A7 is determined.

FIG. 8 is a diagram showing the positional relationships between the base areas indicated by the icons on the vote screen shown in FIG. 7. In the example shown in FIG. 8, a course where the player objects take multiple laps around an intra-base route CA14 in the base area A14 is internally determined as the “entrusted course”.

As shown in FIG. 8, the base areas A7 and A14 are base areas that are located in directions opposite to the directions from the origin area (the base area A5) to the two base areas A2 and A4, and are somewhat away from the origin area.

In a case where two base areas are extracted in the second process, first, the first base area in the second process is extracted using formula 1 based on the two already extracted base areas A2 and A4. Next, the second base area in the second process is extracted using formula 1 based on the three already extracted base areas. A base area set as the “entrusted course” may be the base area extracted first or the base area extracted second between the two base areas extracted in the second process.

If the vote screen is displayed, and the plurality of players vote, any of the four candidates is determined as the course of the next racing game based on the results of the votes. For example, if the course indicated by the icon ICX2 is determined on the vote screen in FIG. 7, the next racing game using the course is performed. Specifically, the plurality of player objects start from the starting point (the gate) of the origin area where the player objects are currently present, pass through the inter-base route R5, enter the base area A2, take a lap around the intra-base route CA2 set in the base area A2, and reach a goal point (a gate).

If the course indicated by the icon ICY7 is determined, the plurality of player objects teleport from the origin area where the player objects are currently present to the base area A7, and perform the next race in the base area A7. Specifically, the plurality of player objects start from a starting point (a gate) provided in the intra-base route CA7 in the base area A7, take multiple laps around the intra-base route CA7, and reach a goal point (a gate) provided in the intra-base route CA7.

If the “entrusted course” indicated by the icon ICZ is determined, the plurality of player objects move from the origin area where the player objects are currently present to the internally determined base area A14, and perform the next race in the base area A14. Specifically, the plurality of player objects start from a starting point provided on the intra-base route CA14 in the base area A14, take multiple laps around the intra-base route CA14, and reach a goal point provided on the intra-base route CA14.

As described above, in the exemplary embodiment, the vote screen presents a plurality of candidates including candidates of the first type and a candidate of the second type to the players. Consequently, it is possible to cause the players to perform racing games on various courses such as a course where the player objects start from a base area where the player objects are currently present, pass through an inter-base route, and move to another base area, and a course where the player objects move from a base area where the player object are currently present to a base area away from the base area, and run in the base area at the movement destination. Thus, it is possible to cause a player to perform a racing game using a wide range on a field.

As shown in FIG. 7, if the current vote screen displays an icon ICY indicating a course of the second type (a course where the player objects take laps around an intra-base route), the number of candidates of the first type to be extracted in the first process when the next vote screen is generated is set to “3”. That is, the current vote screen displays the icon ICY, a course is determined based on the results of votes, the next racing game is performed using the determined course, and the next vote screen is generated after the next racing game ends. In the first process when the next vote screen is generated, the number of candidates of the first type to be extracted is set to “3”. Consequently, the next vote screen can present many candidates of the first type.

There is also a case where no candidate of the first type is extracted in the first process. In this case, four candidates of the second type are extracted in the second process.

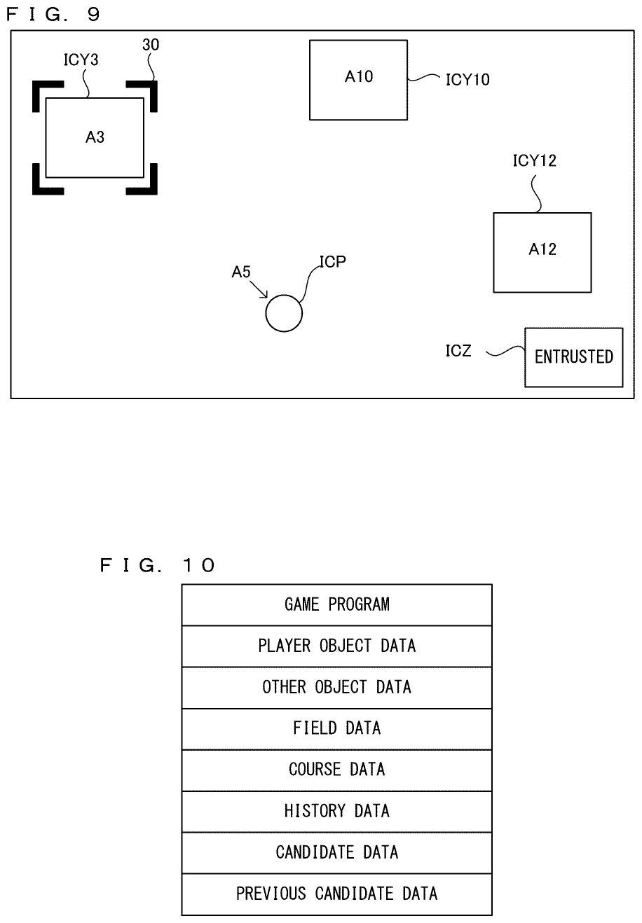

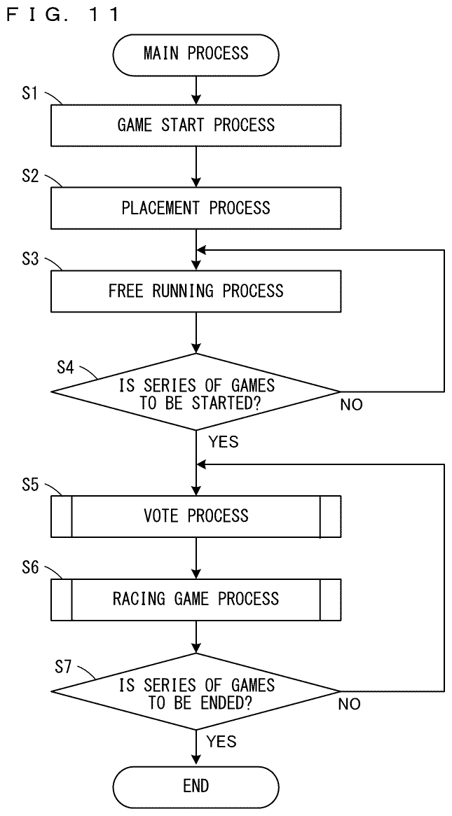

FIG. 9 is a diagram showing an example of the vote screen in a case where no candidate of the first type is extracted in the first process. For example, as shown in FIG. 9, an icon ICY3 indicating the base area A3, an icon ICY10 indicating the base area A10, and an icon ICY12 indicating the base area A12 are displayed. These three icons ICY3, ICY10, and ICY12 indicate base areas that are not joined to the origin area by inter-base routes, and each indicate a course where the player objects take multiple laps around an intra-base route in each base area. A dashed line from the origin area (the base area A5) to each icon is not displayed. The positional relationships between these icons on the vote screen correspond to the positional relationships between the base areas on the field. The icon ICZ corresponding to the “entrusted course” is also displayed at the lower right of the screen.

If no candidate of the first type is extracted in the first process, three base areas are extracted in order using formula 1 in the second process. In the extraction of the first base area, since there is not an “already extracted base area”, only the second term in formula 1 (the value regarding the distance from the base area A5) is calculated, and the first base area is extracted based on the value of the second term. The second base area is extracted using formula 1 based on the base area extracted first. The same applies to the third and subsequent base areas.

A description has been given above of a case where in a case where a plurality of racing games are performed in order, the above vote screen is displayed after a previous racing game ends and before a next racing game is started. Here, the “previous racing game” is any racing game in a series of games (a session of games) where the plurality of racing games are performed in order.

Also before the first racing game in the series of games is started, the above vote screen is displayed. In this case, the base area closest to a particular player object among the plurality of player objects is set as an “origin area”.

Specifically, if players give instructions to start an online multiplay game, main body apparatuses 2 transmit requests regarding the online multiplay game to the server on the Internet. The server receives the requests and matches the plurality of players. If matching is established, the server starts a series of games (a session of games). Before matching is established (before a predetermined number of players gather), the server places player objects corresponding to the players at various positions on the field. For example, the server determines the positions of the player objects and transmits information regarding the positions to main body apparatuses 2. Each main body apparatus 2 receives the information regarding the positions from the server and places the player object at the position determined by the server. Before matching is established, each player can cause the placed player object to freely run on the field. If matching is established, the base area closest to the position of a particular player object among the plurality of player objects is set as an “origin area”. All the matched player objects are moved to the origin area. For example, a main body apparatus 2 corresponding to a particular player object identifies the base area closest to the position of the particular player object and transmits the identified information regarding the base area to the server. The server transmits the identified information regarding the base area to main body apparatuses 2 of all the matched players. Each main body apparatus 2 receives the identified information regarding the base area from the server, moves the player object of the main body apparatus 2 to the identified base area, and sets the identified base area as an origin area.

A description has been given above of an example where the vote screen is displayed in a case where the racing game is performed in the online multiplay mode. Also in a case where the racing game is performed in the offline multiplay mode, the vote screen is displayed, and the course of a next racing game is determined by votes of a plurality of players.

Also in a case where the racing game is performed in the single play mode, the above vote screen is displayed. In this case, a course selected by a player on the vote screen is used as the course of a next racing game.

### (Details of Processing)

Next, a description is given of specific processing regarding the votes for a next course described above.

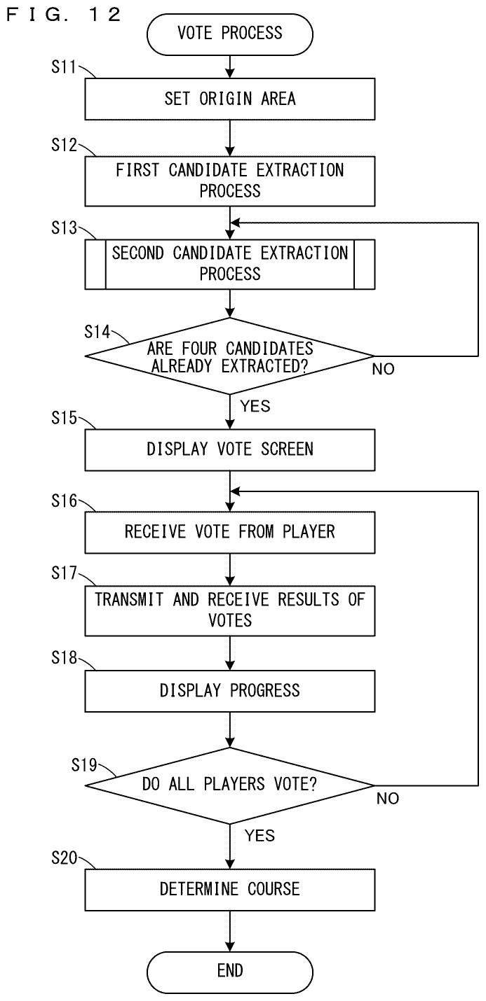

FIG. 10 is a diagram showing examples of various pieces of data used in processes shown in FIGS. 11 to 14. The various pieces of data shown in FIG. 10 are stored in a memory (e.g., the DRAM 27, a storage medium attached to the slot 29, or the flash memory 26) of the main body apparatus 2. At least some of the various pieces of data shown in FIG. 10 may be stored in the server.

As shown in FIG. 10, the memory (e.g., the DRAM 27, the storage medium attached to the slot 29, the flash memory 26 or a memory in the server) stores a game program, player object data, other object data, field data, course data, history data, candidate data, and previous candidate data.

The game program is a program for executing processes described below according to the exemplary embodiment (the processes shown in FIGS. 11 to 14). For example, the game program is stored in advance in the storage medium attached to the slot 29 or the flash memory 26 and is loaded into the DRAM 27 when the racing game is executed.

The player object data is data regarding a player object controlled by the player of the main body apparatus 2. The player object data includes data indicating the shape of the player object, position/orientation data indicating the position and the orientation of the player object, and velocity/acceleration data indicating the velocity and the acceleration of the player object.

The other object data is data regarding a player object of another player (referred to as “another object”) different from the player of the main body apparatus 2. Similarly to the player object data, the other object data includes position/orientation data indicating the position and the orientation of the other object, and velocity/acceleration data indicating the velocity and the acceleration of the other object. For example, the other object data is acquired from another main body apparatus 2 via the server on the Internet.

The field data is data indicating the entirety of the field F. The field data includes data indicating a plurality of base areas and data indicating a plurality of inter-base routes.

The course data is data regarding courses where the racing game is performed. In the exemplary embodiment, the courses where the racing game is performed include a course of the first type where the player objects start from a base area, pass through an inter-base route, and reach another base area, and a course of the second type where the player objects take multiple laps around an intra-base route set in a base area. The course data is stored in advance, and when the racing game starts, the course data is read, and a course is set on the field.

The history data is data regarding a base area used in the most recent predetermined number of races. The base area used in the most recent predetermined number of races is a base area that the player objects pass through or reach in the most recent predetermined number of racing games. Examples of the base area used in the most recent predetermined number of races include a base area that is a starting point of a course of the first type in the most recent predetermined number of races and a base area that is a goal point of a course of the first type or a course of the second type.

The candidate data is data indicating a candidate for the course of a next racing game displayed on the vote screen. The candidate data includes data regarding four candidates. The candidate data is generated based on the first process and the second process that are described above.

The previous candidate data is data regarding four candidates displayed on the previous vote screen.

### (Main Process)

Next, a main process executed by processor 21 of the main body apparatus 2 is described. FIG. 11 is a flow chart showing an example of the main process. For example, the main process shown in FIG. 11 is executed in accordance with the giving of instructions to start the above series of games by the player. Here, a case is described where the above game is performed in the online multiplay mode.

First, the processor 21 performs a game start process for starting the series of games (step S1). In the game start process, the processor 21 transmits a request regarding an online multiplay game to the server. The server receives the requests from the plurality of main body apparatuses 2 and matches the plurality of players. If the server receives the request from the main body apparatus 2, the server determines the placement position of the player object on the field and transmits position information regarding the placement position to the main body apparatus 2. The processor 21 receives the position information.

Next, the processor 21 performs a placement process (step S2). Specifically, the processor 21 places the player object at a position on the field corresponding to the position information received from the server.

Next, the processor 21 performs a free running process (step S3). Specifically, the processor 21 executes the process of acquiring operation data corresponding to an operation of the player, the process of controlling the player object based on the acquired operation data, and a drawing process. Here, the processor 21 causes the player object to freely run on the field in accordance with the operation of the player.

Next, the processor 21 determines whether or not to start the series of games (step S4). Specifically, the processor 21 determines whether or not a start instruction to start the series of games is received from the server. The server receives the request transmitted in the above step S1 from the main body apparatus 2 and matches players. If matching is established, the server transmits a start instruction to start the series of games to the main body apparatus 2. A main body apparatus 2 corresponding to any player of the plurality of matched players may be set as a host terminal.

If it is not determined that the series of games is to be started (step S4: NO), the processor executes the process of step S3 again. The process of step S3 are repeatedly executed at predetermined frame time intervals (e.g., 1/60-second intervals). Consequently, before the series of games is started, a game is performed where the player object is caused to freely run on the field.

If, on the other hand, it is determined that the series of games is to be started (step S4: YES), the processor executes a vote process (step S5). The details of the vote process will be described below.

After the vote process in step S5, the processor 21 executes a racing game process (step S6). Here, a racing game is performed using a course determined in the vote process. The details of the racing game process will be described below.

If the racing game process ends, the processor 21 determines whether or not to end the series of games (step S7). For example, the processor 21 determines whether or not an instruction to end the series of games is given by the player. The series of games may be ended if the racing game process is performed a predetermined number of times.

If it is determined that the series of games is not to be ended (step S7: NO), the processor 21 executes the process of step S5 again.

If, on the other hand, it is determined that the series of games is to be ended (step S7: YES), the processor 21 ends the main process shown in FIG. 11.

If the series of games is performed in the offline multiplay mode using a plurality of main body apparatuses 2, the main process may be started from the process of step S5 by omitting the processes of the above steps S1 to S4. The same applies to a case where the series of games is performed in the single play mode.

### (Vote Process)

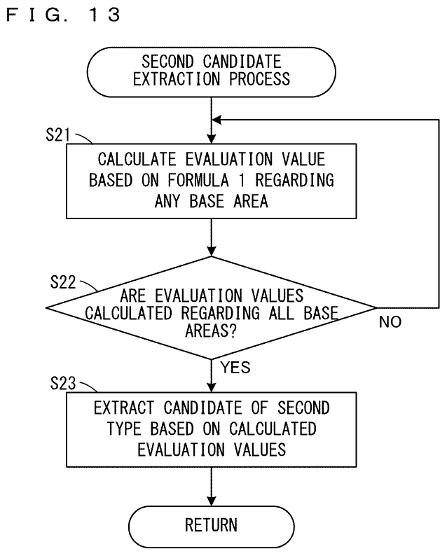

Next, a description is given of the vote process regarding the above votes for a next course. FIG. 12 is a flow chart showing an example of the vote process in step S5. The vote process shown in FIG. 12 is the process for generating the above vote screen and determining a course to be used in a next racing game. The process shown in FIG. 12 is executed after the racing game process (FIG. 14 described below) regarding a previous racing game ends. The process shown in FIG. 12 is performed before the racing game process regarding the first racing game in the series of games is started.

In the exemplary embodiment, the description is given on the assumption that the processes of steps shown in FIG. 12 are executed by the processor 21 of each main body apparatus 2 executing the game program using the memory (e.g., the DRAM 27). The processor 21 of the main body apparatus 2 may execute some of the processes of the steps, and another processor (e.g., a dedicated circuit or the like) provided in the main body apparatus 2 may execute other processes. Some of the processes of the steps shown in FIG. 12 may be performed by the server on the Internet. The processes of all of the steps are merely illustrative. Thus, the processing order of the steps may be changed, or another process may be performed in addition to (or instead of) the processes of all of the steps, so long as similar results are obtained.

As shown in FIG. 12, first, the processor 21 sets an origin area (step S11). Here, for example, if the previous racing game using a course of the first type where a first base area is a goal point ends, the processor 21 sets the first base area as an origin area. For example, if the previous racing game using a course of the second type where the player objects take multiple laps around a first base area ends, the processor 21 sets the first base area as an origin area. If the main body apparatus 2 including the processor 21 is set as a host terminal, the processor 21 sets the base area closest to the position of the player object corresponding to the main body apparatus 2 as an origin area before the first racing game in the series of games is started. The host terminal transmits origin area information regarding the set origin area to the other main body apparatuses 2 via the server. If the main body apparatus 2 including the processor 21 is not set as a host terminal, the processor 21 receives origin area information before the first racing game in the series of games is started, and sets an origin area based on the information. Consequently, the player objects are placed in the same base area. The server may set the base area closest to the position of the player object corresponding to a host terminal as an origin area and transmit origin area information to the plurality of main body apparatuses 2.

Next, the processor 21 performs a first candidate extraction process (step S12). Here, base areas joined to the origin area by inter-base routes R are extracted as candidates of the first type. Specifically, the processor 21 determines the number of candidates of the first type to be extracted in the first candidate extraction process based on a random lottery. The number to be determined is up to “3”. Based on previously extracted data, the processor 21 determines whether or not an icon ICY is displayed on the previous vote screen. If an icon ICY is displayed on the previous vote screen, the processor 21 determines the number of candidates of the first type to be extracted in the first candidate extraction process as “3”. If the course used in the previous racing game is not a course of the second type (i.e., is a course of the first type), the number of candidates of the first type to be extracted in the first candidate extraction process is up to “2” with a fixed probability. Next, with reference to the history data, the processor 21 eliminates a base area used in the most recent predetermined number of races among the base areas joined to the origin area by the inter-base routes R, and extracts the determined number of base areas from the remaining base areas based on a random lottery. The information regarding the base areas extracted here is saved as the candidate data.

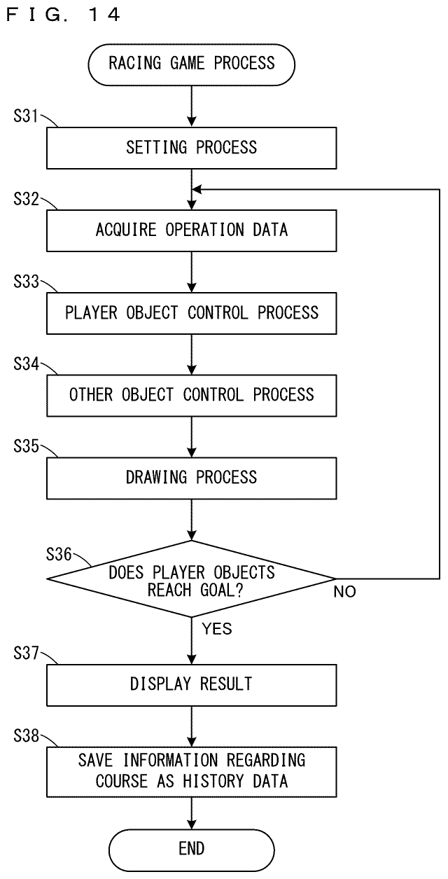

Next, the processor 21 performs a second candidate extraction process (step S13). Here, a base area that is not joined to the origin area by an inter-base route R and is relatively away from the origin area is extracted as a candidate of the second type. The details of the second candidate extraction process are described below. FIG. 13 is a flow chart showing an example of the second candidate extraction process in step S13.

As shown in FIG. 13, the processor 21 calculates the evaluation value based on formula 1 regarding any base area set on the field (step S21). Specifically, first, the processor 21 calculates the vector “uₙ” from the origin area to each base area extracted in step S12. Then, the processor 21 calculates the evaluation value using formula 1 regarding a single base area set on the field. The base area used in the most recent predetermined number of races is eliminated from calculation targets of the evaluation values.

Next, the processor 21 determines whether or not the evaluation values are calculated regarding all the base areas as the calculation targets (step S22). Specifically, the processor 21 determines whether or not the evaluation values are calculated regarding base areas other than the base area used in the most recent predetermined number of races among all the base areas set on the field. If the evaluation values are calculated regarding all the base areas as the calculation targets (step S22: YES), next, the processor 21 performs the process of step S23. If the evaluation values are not calculated regarding all the base areas as the calculation targets (step S22: NO), the processor 21 performs the process of step S21 again and calculates the evaluation value of a base area that has not yet been calculated.

Next, in step S23, the processor 21 extracts a single base area as a candidate of the second type based on the calculated evaluation values of the base areas. For example, the processor 21 determines any one of the top four base areas having high evaluations (specifically, four base areas of which the calculated evaluation values are small) based on random extraction. Specifically, the processor 21 holds a lottery so that the higher evaluation the base area has (the smaller evaluation value the base area has), the higher the probability of extraction of the base area is. The information regarding the base area extracted here is saved as the candidate data.

If the process of step S23 is executed, the processor 21 ends the process shown in FIG. 13, and the processing returns to FIG. 12.

Referring back to FIG. 12, the processor 21 determines whether or not four candidates are already extracted (step S14). If four candidates are not already extracted (step S14: NO), the processor 21 performs the process of step S13 again.

If four candidates are already extracted (step S14: YES), the processor 21 displays the vote screen including the four candidates (step S15). For example, if a single base area is extracted in the second candidate extraction process, the processor 21 displays the vote screen including an icon ICP indicating the player object, three icons ICX that identify three base areas extracted in the first candidate extraction process, and an icon ICZ that does not identify the single base area extracted in the second candidate extraction process (FIG. 5). For example, if two base areas are extracted in the second candidate extraction process, the processor 21 displays the vote screen including an icon ICP indicating the player object, two icons ICX that identify two base areas extracted in the first candidate extraction process, a single icon ICY that identifies one of the two base areas extracted in the second candidate extraction process, and an icon ICZ that does not identify the other of the two base areas extracted in the second candidate extraction process (FIG. 7).

Next, the processor 21 receives a vote from the player (step S16). Here, based on operation data from the controllers, the processor 21 determines whether or not any of the plurality of candidates (icons) is selected by the player. After the player votes for any of the candidates, the processor 21 skips the process of step S16.

Next, the processor 21 transmits and receives the results of votes (step S17). Specifically, if the player votes in step S16, the processor 21 transmits the result of the vote to the server on the Internet. The processor 21 also receives the results of votes of the other players from the other main body apparatuses 2 via the server.

Next, the processor 21 displays the progress of the votes (step S18). Here, whether or not the players vote and for which candidates the players vote are displayed in real time. For which candidates the other players vote may be specifically displayed, or for which candidate the other player votes may not be specifically displayed, and only whether or not the other players vote may be displayed.

Next, the processor 21 determines whether or not all the players vote (step S19).

If not all the players vote (step S19: NO), the processor 21 executes the process of step S16 again. If a predetermined period elapses since the vote screen is displayed, the determination of the processor 21 may be YES in step S19.

If all the players vote (step S19: YES), the processor 21 determines the course to be used in the next racing game (step S20). For example, any of the plurality of main body apparatuses 2 performing the game in the online multiplay mode (e.g., a host terminal) may determine any one of the four candidates as the course to be used in the next racing game based on the results of the votes of the players. Alternatively, the server may determine any one of the four candidates as the course to be used in the next racing game based on the results of the votes of the players. The host terminal or the server transmits information indicating the determined course to the main body apparatuses 2. Then, the processors 21 of the main body apparatuses 2 may set (determine) the course to be used in the next racing game based on the information received from the host terminal or the server in step S20.

After the process of step S20 is performed, the processor 21 ends the process shown in FIG. 12. The information regarding the four candidates extracted in the current vote process is stored as the previous candidate data.

If the vote process shown in FIG. 12 is performed, next, the racing game process shown in FIG. 14 is performed. FIG. 14 is a flow chart showing an example of the racing game process in step S6.

### (Racing Game Process)

First, the processor 21 performs a setting process for starting a racing game (step S31). Here, the processor 21 sets the determined course on the field and places the player objects at a starting point of the set course. Then, the processor 21 starts the racing game using the set course.

If the racing game is started, the processor 21 acquires operation data (step S32). Specifically, the processor 21 acquires the operation data from the controllers 3 and 4. From this point onward, the processor 21 repeatedly executes the processes of steps S32 to S36 at predetermined frame time intervals (e.g., 1/60-second intervals).

Next, the processor 21 executes a player object control process (step S33). Here, based on the operation data, the processor 21 updates information regarding the player object. For example, the processor 21 updates the position, the orientation, the velocity, and the like of the player object and causes the player object to perform a predetermined action. In accordance with the update of the position of the player object, the processor 21 also updates the position of the virtual camera. The processor 21 also transmits the updated information regarding the player object to the other main body apparatuses 2 (via or not via the server).

Next, the processor 21 executes an other object control process (step S34). Here, a process regarding the other objects corresponding to the other players that perform the racing game with the player object is performed. Specifically, the processor 21 receives information regarding the plurality of other objects from the plurality of other main body apparatuses 2 (via or not via the server), and based on the received information, updates the position, the orientation, the velocity, and the like of each of the plurality of other objects. Based on the received information, the processor 21 also causes each of the plurality of other objects to perform a predetermined action.

Next, the processor 21 performs a drawing process (step S35). In the drawing process, the processor 21 generates a game image based on the virtual camera corresponding to the player object and outputs the generated game image to the display 12 or an external display device.

Next, the processor 21 determines whether or not the player objects reach a goal (step S36). Specifically, the processor 21 determines whether or not all movable objects including the player object and the other objects reach a goal point set in the course. If not all the movable objects reach the goal (step S36: NO), the processor 21 executes the process of step S32 again.

If all the movable objects reach the goal (step S36: YES), the processor 21 displays the result of the current racing game (step S37), and saves information regarding the course used in the current racing game as the history data (step S38). The history data saved here will be used when candidates for courses in next and subsequent racing games are generated. Then, the processor 21 ends the racing game process regarding the current racing game.

As described above, in the game according to the exemplary embodiment, a plurality of base areas are set on the field, and an intra-base route CA is set in each base area. On the field, an inter-base route R connecting base areas is set. It is possible to set a course of the first type where player objects start from a certain base area, pass through an inter-base route R, and reach another base area, and perform a racing game by a plurality of movable objects in the course. It is also possible to set a course of the second type where player objects take multiple laps around an intra-base route, and perform a racing game by a plurality of movable objects in the course.

In the exemplary embodiment, after a previous racing game ends, the vote screen presents, as candidates for the course of a next racing game, a plurality of candidates including candidates of the first type corresponding to a course of the first type and candidates of the second type corresponding to a course of the second type to players. Specifically, as the candidates of the first type, candidates for a course where, with a base area where a goal point is set in the course of the previous racing game as an origin area, player objects start from the origin area, pass through an inter-base route, and reach another base area are presented. As the candidates of the second type, candidates for a course including an intra-base route in a base area different from the origin area are presented. Consequently, it is possible to present candidates for a variety of courses to the players, cause the player to perform a racing game, and cause the player to perform the racing game using a wide field.

As the candidates of the second type, base areas present in directions different from the directions from the origin area to the candidates of the first type are presented. As the candidates of the second type, base areas that are not too close to or too far from the origin area are presented. Consequently, it is possible to present base areas at different places on the field, and it is possible to cause the players to perform the racing game using various places on the field.

In the exemplary embodiment, when a candidate of the second type is generated, an evaluation based on a condition regarding a direction and a condition regarding a distance is performed, and any of a plurality of candidates having high evaluations is randomly selected. Consequently, it is possible to cause the players to perform the racing game at various places on the field and balanced places.

As described above, in the exemplary embodiment, after a previous racing game ends in a course where a goal point is set in a first base area (e.g., the base area A5), as candidates for the course of a next racing game, candidates for a plurality of courses including a candidate of the first type (ICX2 or ICX4 in FIG. 7) corresponding to a course of the first type including an inter-base route R from the first base area to a second base area (e.g., the base area A2 or A4) and a candidate of the second type (ICZ or ICY7 in FIG. 7) corresponding to a course of the second type including an intra-base route in a third base area different from the first base area are generated and presented to the players.

Consequently, the players can select the course where the player objects move from the first base area to the second base area joined to the first base area by the inter-base route R, and can obtain a feeling that the player objects continuously move on the wide field. The third base area different from the first base area is presented as a candidate of the second type, whereby, for example, the players can move to the third base area away from the first base area and perform a racing game. Thus, it is possible to perform the game by utilizing the wide field. It is also possible to set a variety of courses regarding the course of the next racing game.

The candidate of the first type may be candidates for a plurality of courses including inter-base routes from the first base area to a plurality of second base areas. Consequently, the players can select any of a plurality of candidates of the first type and can continuously move the player objects on the field in various paths.

The course of the first type may be a course where an intra-base route in the second base area is set after the inter-base route connecting the first and second base areas, and the course of the second type may be a course where the player objects take multiple laps around the intra-base route in the third base area. Consequently, no matter which type the type of the candidate selected by the players is, the players can cause the player objects to run the intra-base route.

The third base area is set based on a first condition regarding the direction on the field from the first base area (e.g., the first term of formula 1) and a second condition regarding the distance from the first base area (e.g., the second term of formula 1) among a plurality of base areas on the field. Specifically, regarding the plurality of base areas on the field, evaluations are calculated so that the further away from the direction from the first base area to the second base area the direction on the field from the first base area is, the higher the evaluation is, and the closer to a predetermined distance the distance from the first base area is, the higher the evaluation is. The third base area is set among base areas having the high evaluations.

Consequently, as the third base area, a certain base area in a direction different from the direction from the first base area to the second base area can be presented. As the third base area, a certain base area at a predetermined distance from the first base area can also be presented. Thus, it is possible to prevent the racing game from being performed at imbalanced positions on the field, and it is possible to move the player objects in a wide range on the field.

The second and third base areas are set from base areas other than a base area that the player objects reach or pass through in the most recent predetermined number of racing games among a plurality of base areas on the field. Consequently, it is possible to prevent the racing game using the same base area as a base area that the player objects pass through or reach in the most recent race from being performed.

A candidate presentation UI (e.g., a vote screen) including information that identifies a base area regarding a candidate of the first type (e.g., an icon ICX) and information that does not identify a base area regarding a candidate of the second type (e.g., an icon ICZ) is displayed. Consequently, each player can select a candidate indicating a desired base area. The player can move the player object to a base area which is away from a base area where the player object is currently present, and of which the destination is unknown, and perform the racing game.

As a candidate for the course of a next race, a candidate of a third type corresponding to a course of a third type where a starting point is set in a fourth base area (e.g., the base area A7) different from the first base area and which includes an intra-base route in the fourth base area is generated, and a candidate presentation UI (FIG. 7) further including information that identifies the fourth base area regarding the candidate of the third type (e.g., an icon ICY) is displayed.

Consequently, the player can move the player object to a base area which is away from a base area where the player object is currently present, and of which the destination is known, and perform the racing game. Even in a case where a predetermined number of candidates of the first type cannot be presented, it is possible to present the shortfall as a candidate of the third type.

In the exemplary embodiment, before a race starts, an operation object is caused to run on the field. Before the first race starts, as candidates for the course of the first race, candidates for a plurality of courses at least including a candidate of the first type corresponding to a course of the first type where a starting point is set in a fifth base area closest to the position of the operation object among base areas and which includes an inter-base route from the fifth base area to a sixth base area, and a candidate of the second type corresponding to a course of the second type where a starting point is set in a seventh base area different from the fifth base area and which includes an intra-base route in the seventh base area are generated.

Consequently, also regarding the first race, it is possible to allow the player to select either of the candidate of the first type and the candidate of the second type.

In the exemplary embodiment, it is possible to determine a course corresponding to a candidate selected based on an operation input as the course of a next race. Consequently, it is possible to set a candidate selected by the player as the course of a next race.

In the exemplary embodiment, a racing game is performed by a plurality of players based on communication, and any of candidates selected by the plurality of players is determined as the course of a next race. Consequently, in a racing game performed by a plurality of players, it is possible to determine the course of a next race by selection of the plurality of players.

### (Variations)

While the exemplary embodiment has been described above, the exemplary embodiment is merely an example and may be modified as follows, for example.

For example, in the above exemplary embodiment, a course of the first type is a course where the player objects start from a first base area, pass through an inter-base route R, enter a second base area, and take a lap around an intra-base route in the second base area. The course of the first type may be any course so long as the course includes an inter-base route R between a first base area and a second base area. For example, the course of the first type may be a course where the player objects take a predetermined number of laps (or do not take laps) around an intra-base route in a first base area, pass through an inter-base route R, enter a second base area, do not take laps around an intra-base route in the second base area, and reach a goal point set in the second base area. The course of the first type may be a course where the player objects take a predetermined number of laps (or do not take laps) around an intra-base route in a first base area, pass through an inter-base route R, enter a second base area, take a predetermined number of laps (or do not take laps) around an intra-base route in the second base area, further pass through another inter-base route R, further enter another base area, and reach a goal. The above vote screen may present candidates for such a course of the first type to the players.

In the above exemplary embodiment, a course of the second type is a course where the player objects take multiple laps around an intra-base route set in a base area and reach a goal point set in the intra-base route. The course of the second type may be a course where the player objects take multiple laps around an intra-base route set in a base area, further pass through an inter-base route R, and reach another base area. The above vote screen may present candidates such a course of the second type to the players.

In the above exemplary embodiment, as a candidate for a course of the second type, a course where the player objects take multiple laps around an intra-base route in a third base area at a position somewhat away from a first base area where the player objects are present is presented. The third base area may be a base area at a position relatively close to the first base area, or may be a base area at a position far from the first base area so long as the third base area is a base area different from the first base area.

In the above exemplary embodiment, a plurality of base areas are evaluated using formula 1, and candidates of the second type having high evaluations are extracted. In another exemplary embodiment, a plurality of base areas may be evaluated using another formula different from formula 1.

In the above exemplary embodiment, the vote screen necessarily displays a single “entrusted course”. In another exemplary embodiment, there may be a case where an “entrusted course” is not displayed, or there may be a case where a plurality of “entrusted courses” are displayed.

In the above exemplary embodiment, the vote screen displays the “entrusted course” in a form that does not allow the players to identify a base area. In another exemplary embodiment, the “entrusted course” may be displayed in a form that allows the players to identify a base area.

In the above exemplary embodiment, the above vote screen (a candidate presentation UI) is displayed for each of the plurality of players, and each of the plurality of players votes for a candidate for a course presented on the vote screen. The candidate presentation UI (a user interface) may be displayed also in a case where a racing game is performed in the single play mode. In this case, a player selects any of a plurality of candidates presented on the candidate presentation UI, and the selected candidate is determined as the course of a next race. Also in a case where a racing game is performed in a multiplay mode, the candidate presentation UI may be displayed on a screen for a single player, the single player may select any of a plurality of candidates presented on the candidate presentation UI on behalf of the plurality of players, and the selected candidate may be determined as the course of a next race.

The above processing may be executed not only by the main body apparatus 2, but also by any other information processing apparatus such as a smartphone or a tablet terminal. The above processing may be executed by an information processing system including a plurality of apparatuses connected together via a network (e.g., a LAN, the Internet, or the like).

For example, in the above exemplary embodiment, the main body apparatus 2 executes the process shown in FIG. 12. However, at least a part of the process shown in FIG. 12 may be performed by the server. For example, the first candidate extraction process and the second candidate extraction process may be performed by the server. The server may collect the results of the votes of the plurality of players from the plurality of main body apparatuses 2 and determine the course of the next racing game based on the results of the votes. An information processing system including the plurality of main body apparatuses 2 and the server may execute the processes shown in FIGS. 12 to 14.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute game processing comprising:
causing an operation object to run on a field in a virtual space based on an operation input;
setting a plurality of base areas on the field;
if a start instruction to start a race between the operation object and at least one movable object different from the operation object is given based on an operation input,
setting on the field a course which corresponds to the determined race and which includes at least either of an intra-base route that is a path set in any one of the base areas and an inter-base route set as a path connecting two of the base areas and where a goal point is set in any of the base areas, and starting the race;
causing the operation object and the movable object to run along the set course on the field in the race;
after a first race in a course where a goal point is set in a first base area ends, generating, as candidates for a course of a next second race, candidates for a plurality of courses at least including a candidate of a first type corresponding to a course of the first type where a starting point is set in the first base area and which includes the inter-base route from the first base area to a second base area, and a candidate of a second type corresponding to a course of the second type where a starting point is set in a third base area different from the first base area and which includes an intra-base route in the third base area;
selecting any of the candidates for the plurality of courses based on an operation input and determining the course of the second race based on the selection; and
setting the determined course on the field and starting the second race.

2. The one or more non-transitory computer-readable media according to claim 1, wherein
the course of the first type is a plurality of courses including the inter-base route from the first base area to each of a plurality of the second base areas.

3. The one or more non-transitory computer-readable media according to claim 1, wherein
the course of the first type is a course where the intra-base route in the second base area is set after the inter-base route from the first base area to the second base area, and
the course of the second type is a course where the operation object and the movable object take multiple laps around the intra-base route in the third base area.

4. The one or more non-transitory computer-readable media according to claim 1, wherein
the third base area is set based on a first condition regarding a direction on the field from the first base area from among the plurality of base areas on the field.

5. The one or more non-transitory computer-readable media according to claim 1, wherein
the third base area is set based on a second condition regarding a distance from the first base area from among the base areas on the field.

6. The one or more non-transitory computer-readable media according to claim 1, wherein
regarding the plurality of base areas on the field, evaluations are calculated so that the further away from a direction from the first base area to the second base area a direction on the field from the first base area is, the higher the evaluation is, and the closer to a predetermined distance a distance from the first base area is, the higher the evaluation is, and the third base area is set from base areas having the high evaluations based on the calculated evaluations.

7. The one or more non-transitory computer-readable media according to claim 1, wherein
the second and third base areas are set from base areas other than the base area that the operation object and the movable object reach or pass through in the most recent predetermined number of races among the base areas on the field.

8. The one or more non-transitory computer-readable media according to claim 1, wherein
the game processing further comprises
after the first race ends,
displaying a candidate presentation UI at least including information that identifies the second base area regarding the candidate of the first type and information that does not identify the third base area regarding the candidate of the second type.

9. The one or more non-transitory computer-readable media according to claim 8, wherein
the game processing further comprises:
generating, as a candidate for the course of the second race, a candidate of a third type corresponding to a course of the third type where a starting point is set in a fourth base area different from the first base area and which includes an intra-base route in the fourth base area; and
displaying the candidate presentation UI further including information that identifies the fourth base area regarding the candidate of the third type.

10. The one or more non-transitory computer-readable media according to claim 1, wherein
the game processing further comprises:
causing the operation object to run on the field before the race starts,
before a third race as the first race starts, generating, as candidates for a course of the third race, candidates for a plurality of courses at least including the candidate of the first type corresponding to the course of the first type where a starting point is set in a fifth base area closest to a position of the operation object among the base areas and which includes the inter-base route from the fifth base area to a sixth base area, and the candidate of the second type corresponding to the course of the second type where a starting point is set in a seventh base area different from the fifth base area and which includes an intra-base route in the seventh base area.

11. The one or more non-transitory computer-readable media according to claim 1, wherein
the game processing further comprises
determining a course corresponding to the candidate selected based on an operation input as the course of the second race.

12. The one or more non-transitory computer-readable media according to claim 1, wherein
the game processing further comprises:
causing a plurality of players to perform a race based on communication; and
determining any of candidates selected by the respective players as the course of the second race.

13. An information processing system comprising:
one or more processors; and
one or more non-transitory computer-readable media storing executable instructions that, when executed, cause the processor to execute game processing comprising:
causing an operation object to run on a field in a virtual space based on an operation input;
setting a plurality of base areas on the field;
if a start instruction to start a race between the operation object and at least one movable object different from the operation object is given based on an operation input,
setting on the field a course which corresponds to the determined race and which includes at least either of an intra-base route that is a path set in any one of the base areas and an inter-base route set as a path connecting two of the base areas and where a goal point is set in any of the base areas, and starting the race;
causing the operation object and the movable object to run along the set course on the field in the race;
after a first race in a course where a goal point is set in a first base area ends, generating, as candidates for a course of a next second race, candidates for a plurality of courses at least including a candidate of a first type corresponding to a course of the first type where a starting point is set in the first base area and which includes the inter-base route from the first base area to a second base area, and a candidate of a second type corresponding to a course of the second type where a starting point is set in a third base area different from the first base area and which includes an intra-base route in the third base area;
selecting any of the candidates for the plurality of courses based on an operation input and determining the course of the second race based on the selection; and
setting the determined course on the field and starting the second race.

14. The information processing system according to claim 13, wherein
the course of the first type is a plurality of courses including the inter-base route from the first base area to each of a plurality of the second base areas.

15. The information processing system according to claim 13, wherein
the course of the first type is a course where the intra-base route in the second base area is set after the inter-base route from the first base area to the second base area, and
the course of the second type is a course where the operation object and the movable object take multiple laps around the intra-base route in the third base area.

16. The information processing system according to claim 13, wherein
the third base area is set based on a first condition regarding a direction on the field from the first base area from among the plurality of base areas on the field.

17. The information processing system according to claim 13, wherein
the third base area is set based on a second condition regarding a distance from the first base area from among the base areas on the field.

18. The information processing system according to claim 13, wherein
regarding the plurality of base areas on the field, evaluations are calculated so that the further away from a direction from the first base area to the second base area a direction on the field from the first base area is, the higher the evaluation is, and the closer to a predetermined distance a distance from the first base area is, the higher the evaluation is, and the third base area is set from base areas having the high evaluations based on the calculated evaluations.

19. The information processing system according to claim 13, wherein
the second and third base areas are set from base areas other than the base area that the operation object and the movable object reach or pass through in the most recent predetermined number of races among the base areas on the field.

20. The information processing system according to claim 13, wherein
the game processing further comprises
after the first race ends,
displaying on a display device a candidate presentation UI at least including information that identifies the second base area regarding the candidate of the first type and information that does not identify the third base area regarding the candidate of the second type.

21. The information processing system according to claim 20, wherein
the game processing further comprises:
generating, as a candidate for the course of the second race, a candidate of a third type corresponding to a course of the third type where a starting point is set in a fourth base area different from the first base area and which includes an intra-base route in the fourth base area; and
displaying on the display device the candidate presentation UI further including information that identifies the fourth base area regarding the candidate of the third type.

22. The information processing system according to claim 13, wherein
the game processing further comprises:
causing the operation object to run on the field before the race starts,
before the first race starts, generating, as candidates for a course of the first race, candidates for a plurality of courses at least including the candidate of the first type corresponding to the course of the first type where a starting point is set in a fifth base area closest to a position of the operation object among the base areas and which includes the inter-base route from the fifth base area to a sixth base area, and the candidate of the second type corresponding to the course of the second type where a starting point is set in a seventh base area different from the fifth base area and which includes an intra-base route in the seventh base area.

23. The information processing system according to claim 13, wherein
the game processing further comprises
determining a course corresponding to the candidate selected based on an operation input as the course of the second race.

24. The information processing system according to claim 13, wherein
the game processing further comprises:
causing a plurality of players to perform a race based on communication; and
determining any of candidates selected by the respective players as the course of the second race.

25. An information processing method for performing a racing game, the information processing method comprising:
causing an operation object to run on a field in a virtual space based on an operation input;
setting a plurality of base areas on the field;
if a start instruction to start a race between the operation object and at least one movable object different from the operation object is given based on an operation input,
setting on the field a course which corresponds to the determined race and which includes at least either of an intra-base route that is a path set in any one of the base areas and an inter-base route set as a path connecting two of the base areas and where a goal point is set in any of the base areas, and starting the race;
causing the operation object and the movable object to run along the set course on the field in the race;
after a first race in a course where a goal point is set in a first base area ends, generating, as candidates for a course of a next second race, candidates for a plurality of courses at least including a candidate of a first type corresponding to a course of the first type where a starting point is set in the first base area and which includes the inter-base route from the first base area to a second base area, and a candidate of a second type corresponding to a course of the second type where a starting point is set in a third base area different from the first base area and which includes an intra-base route in the third base area;
selecting any of the candidates for the plurality of courses based on an operation input and determining the course of the second race based on the selection; and
setting the determined course on the field and starting the second race.

26. The information processing method according to claim 25, wherein
the course of the first type is a plurality of courses including the inter-base route from the first base area to each of a plurality of the second base areas.

27. The information processing method according to claim 25, wherein
the course of the first type is a course where the intra-base route in the second base area is set after the inter-base route from the first base area to the second base area, and
the course of the second type is a course where the operation object and the movable object take multiple laps around the intra-base route in the third base area.

28. The information processing method according to claim 25, wherein
the third base area is set based on a first condition regarding a direction on the field from the first base area from among the plurality of base areas on the field.

29. The information processing method according to claim 25, wherein
the third base area is set based on a second condition regarding a distance from the first base area from among the base areas on the field.

30. The information processing method according to claim 25, wherein
regarding the plurality of base areas on the field, evaluations are calculated so that the further away from a direction from the first base area to the second base area a direction on the field from the first base area is, the higher the evaluation is, and the closer to a predetermined distance a distance from the first base area is, the higher the evaluation is, and the third base area is set from base areas having the high evaluations based on the calculated evaluations.

31. The information processing method according to claim 25, wherein
the second and third base areas are set from base areas other than the base area that the operation object and the movable object reach or pass through in the most recent predetermined number of races among the base areas on the field.

32. The information processing method according to claim 25, further comprising
after the first race ends,
displaying a candidate presentation UI at least including information that identifies the second base area regarding the candidate of the first type and information that does not identify the third base area regarding the candidate of the second type.

33. The information processing method according to claim 32, further comprising:
generating, as a candidate for the course of the second race, a candidate of a third type corresponding to a course of the third type where a starting point is set in a fourth base area different from the first base area and which includes an intra-base route in the fourth base area; and
displaying the candidate presentation UI further including information that identifies the fourth base area regarding the candidate of the third type.

34. The information processing method according to claim 25, further comprising:
causing the operation object to run on the field before the race starts,
before the first race starts, generating, as candidates for a course of the first race, candidates for a plurality of courses at least including the candidate of the first type corresponding to the course of the first type where a starting point is set in a fifth base area closest to a position of the operation object among the base areas and which includes the inter-base route from the fifth base area to a sixth base area, and the candidate of the second type corresponding to the course of the second type where a starting point is set in a seventh base area different from the fifth base area and which includes an intra-base route in the seventh base area.

35. The information processing method according to claim 25, further comprising
determining a course corresponding to the candidate selected based on an operation input as the course of the second race.

36. The information processing method according to claim 25, further comprising:
causing a plurality of players to perform a race based on communication; and
determining any of candidates selected by the respective players as the course of the second race.
